(19) United States
(12) Patent Application Publication
(10) Pub. No.: US 2003/0122000 A1
(43) Pub. Date: Jul. 3, 2003

(54) Atomising disc and fuel injection valve with an atomising disc

(76) Inventors: Wolfgang Dressler, Vaihingen/Enz (DE); Joerg Heyse, Besigheim (DE); Horst Boeder, Biberach (DE)

Correspondence Address: KENYON & KENYON, ONE BROADWAY, NEW YORK, NY, 10004, US

(21) Appl. No.: 10/182,808

(22) PCT Filed: Nov. 30, 2001
(86) PCT No.: PCT/DE01/04502

(30) Foreign Application Priority Data
Dec. 1, 2000 (DE) 100 59 682.7

(51) Int. Cl. F02M 51/00

(52) U.S. Cl. 239/585.1

(57) ABSTRACT

An atomizer disk (23) has at least one inlet (40) and at least one outlet (42) and a complete passage for a fluid between the inlet (40) and the outlet (42). A flow rate sensor (50, 51, 50′, 51′, 150, 151) is integrated into the atomizer disk (23) upstream from a metering cross section of the fluid passage. In this way, the flow through the atomizer disk (23) is controllable in flow operation and is actively regulatable at any time.

The atomizer disk (23) is suitable particularly for use on a fuel injector, in particular a high-pressure fuel injector for direct injection of fuel into a combustion chamber of an internal combustion engine having compression of a fuel mixture and spark ignition.

### BACKGROUND INFORMATION

The present invention relates to an atomizer disk according to the preamble of claim 1 and a fuel injector having an atomizer disk according to the preamble of claim 11.

Unexamined German Patent 196 39 506 among others has already described an electromagnetically operable fuel injector in which an atomizer disk is provided downstream from a valve seat. This atomizer disk is used for fuel conditioning and metered spray-discharge of a shaped fuel spray.

From a wide variety of publications concerning nozzles and injectors in internal combustion engines as well as inkjet printers, nozzles for spraying fluids of all types or inhalers, a wide variety of design variants of atomizer disks are known. They are usually characterized by at least one inlet and at least one outlet and a certain connecting path between the inlet and outlet, which may be very short, for a complete passage of a fluid. The geometric design of the openings determines the flow and has a metering function. Specifically when atomizer disks are used on fuel injectors, the advantages of a high quality spray-discharge, a uniform and extremely fine atomization, and a high variability of spray jet shapes may be achieved through targeted design (e.g., swirl disks, offset disks having the outlet offset relative to the inlet, multi-jet disks) for the fuel injector.

### ADVANTAGES OF THE PRESENT INVENTION

The atomizer disk according to the present invention having the characterizing features of claim 1 has the advantage that it has a high degree of integration of functions. One particular advantage is that a flow rate sensor is integrated into the analyzer disk, so that a very high variability of the flow rate through the atomizer disk is adjustable in flow operation. In this way, flow through the atomizer disk in flow operation is controllable and actively regulatable at any time.

Advantageous refinements of and improvements on the atomizer disk characterized in claim 1 are possible through the measures characterized in the subclaims.

It is particularly advantageous to use as the material for the atomizer disk composite ceramics produced by pyrolysis of filled organosilicon polymers. These are very wear-resistant and corrosion-resistant, so a long lifetime is ensured.

It is advantageous to provide electrically conducting regions directly upstream from the at least one outlet opening. A first electrically conducting region is heatable with electricity, and the temperature of a second electrically conducting region and thus its electrical resistance may be influenced through the fluid flow. The flow rate upstream from the metering cross section of the fluid passage in the atomizer disk may be determined in this way.

The fuel injector according to the present invention having the characterizing features of claim 1 has the advantage that a routine determination of flow rate in the injector during operation of a motor vehicle is possible. Furthermore, the flow rate may be regulated actively at any time.

The accuracy of the flow of injectors need not be ensured through precise geometric dimensions in the metering area, specifically in the outlet orifices of the fuel injector in large numbers, as was customary in the past. Instead, the flow is adjustable and controllable during operation of the engine due to the design of the atomizer disk according to the present invention.

### Drawing

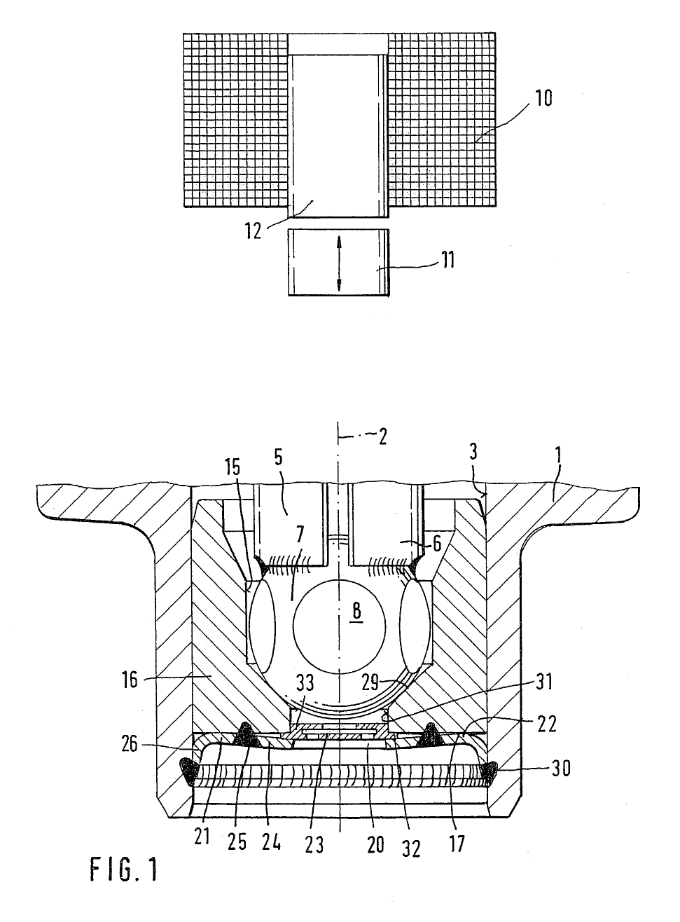

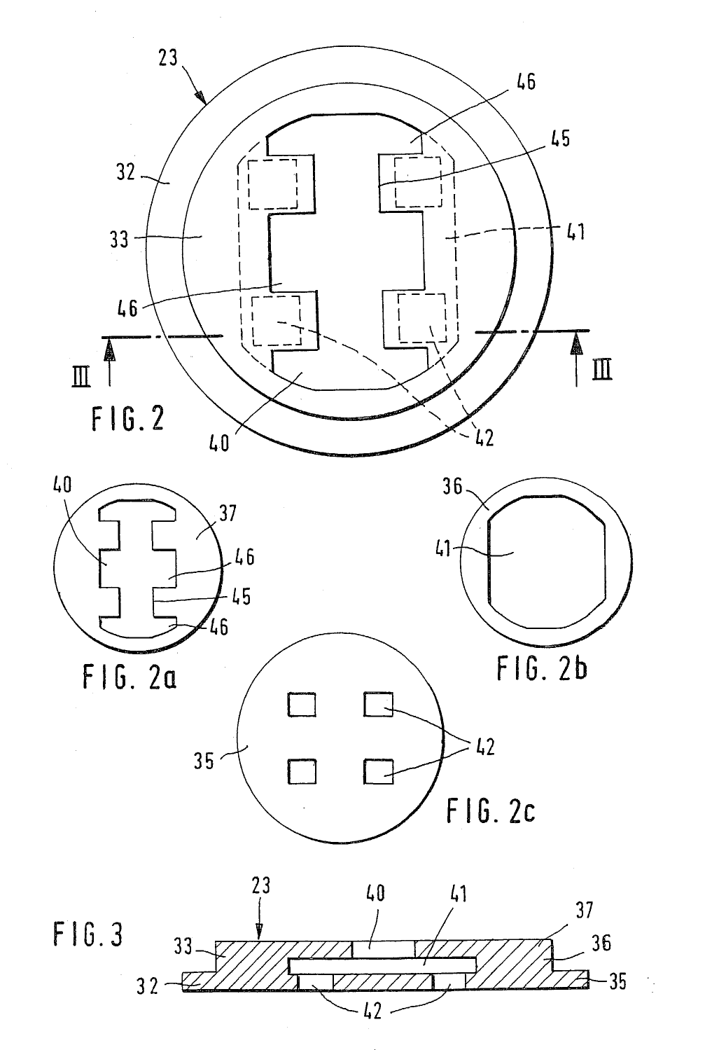

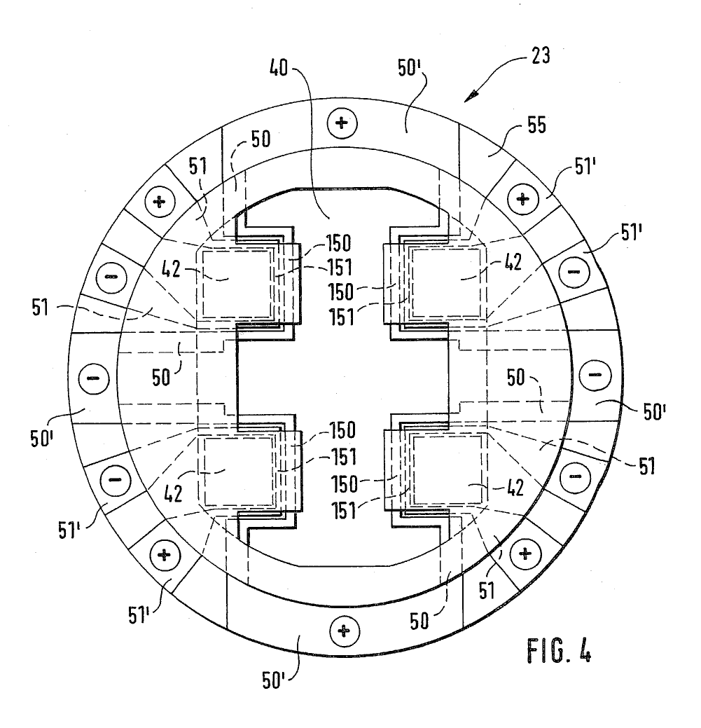

One embodiment of the present invention is illustrated in simplified form in the drawing and is explained in greater detail in the following description. FIG. 1 shows a partial diagram of a fuel injector having an atomizer disk in a sectional view; FIG. 2 shows a top view of an atomizer disk known from Unexamined German Patent 196 39 506 to illustrate and explain a possible design of the atomizer disk according to the present invention; FIGS. 2a through 2c show the individual function levels of the atomizer disk according to FIG. 2; FIG. 3 shows a section along line III-III in FIG. 2; and FIG. 4 shows an exemplary embodiment of an atomizer disk according to the present invention, having an integrated flow rate sensor in a design corresponding to that of the atomizer disk shown in FIG. 2.

### DESCRIPTION OF THE EXEMPLARY EMBODIMENT

The electromagnetically operable valve shown in FIG. 1 as an example in the form of an injector for fuel injection systems of internal combustion engines having mixed fuel compression and spark ignition is especially suitable as a high-pressure injector for direct injection of fuel into a combustion chamber of an engine. An injector (for gasoline or diesel application, for direct injection or intake manifold injection) is only one important application for use of the atomizer disk according to the present invention. These atomizer disks may also be used in inkjet printers, on nozzles for spraying fluids of any type or in inhalers.

The injector has a tubular valve seat carrier 1 in which a longitudinal opening 3 is formed so it is concentric with a longitudinal axis 2 of the valve. For example, a tubular valve needle 5 is situated in longitudinal opening 3, fixedly connected at its downstream end 6 to a valve-closure member 7 in the shape of a ball, for example, having five flattened areas 8, for example, on its circumference to allow fuel to flow past it.

The injector is operated in a known manner, e.g., electromagnetically. An electromagnetic circuit, indicated schematically, having a solenoid 10, an armature 11 and a core 12 is used for axial movement of valve needle 5 and thus for opening it against the spring force of a restoring spring (not shown) and/or for closing the injector. Armature 11 is connected to the end of valve needle 5, which faces away from valve-closure member 7, by a weld produced by a laser, for example, and is aligned with core 12.

A guide opening 15 of a valve-seat member 16, which is mounted tightly by welding in the downstream end of valve seat carrier 1, which faces away from core 12, in longitudinal opening 3 running concentrically with longitudinal axis 2 of the valve, is used to guide valve-closure member 7 during its axial movement. On its lower end face 17, which faces away from valve-closure member 7, valve-seat member 16 is concentrically and fixedly connected to a disk carrier 21, designed in the shape of a pot, for example, which is thus directly in contact with valve-seat member 16 at least in an outer ring area 22. Disk carrier 21 has a shape similar to that of the known pot-shaped spray hole disks, where a central region of disk carrier 21 is provided with a through hole 20 having no metering function.

An atomizer disk 23 according to the present invention is situated upstream from through hole 20 so that it completely covers through hole 20. Disk carrier 21 is designed with a bottom part 24 and a retaining edge 26. Retaining edge 26 extends axially, facing away from valve-seat member 16 and is bent outward conically at its end. Valve-seat member 16 and disk carrier 21 are connected, e.g., by a first hermetically sealing peripheral weld 25 produced by a laser. In the area of retaining edge 26, disk carrier 21 is additionally connected to the wall of longitudinal opening 3 in valve seat carrier 1, e.g., by a second hermetically sealing peripheral weld 30.

Atomizer disk 23, which may be clamped between disk carrier 21 and valve-seat member 16, is designed with step gradations, a lower base area 32 having a larger diameter in particular than the remaining atomizer disk 23. A disk area 33 having this smaller diameter projects with a precise fit into a cylindrical outlet opening 31 of valve-seat member 16 following downstream from a valve-seat surface 29. Base area 32 of atomizer disk 23, which projects outward radially and thus may be clamped in place, is in contact with lower end face 17 of valve-seat member 16.

Although disk area 33 has two function levels, for example, namely a middle function level and an upper function level, which includes atomizer disk 23, a lower function level forms base area 32 alone. A function level should have a largely constant opening contour over its axial extent.

The depth of insertion of the valve seat part, which is composed of a valve-seat member 16, pot-shaped disk carrier 21 and atomizer disk 23, into longitudinal opening 3 determines the size of the lift of valve needle 5, because the one end position of valve needle 5 when solenoid 10 is not energized is determined by the contact of valve-closure member 7 with valve-seat surface 29 of valve-seat member 16. The other end position of valve needle 5 is determined, for example, by contact of armature 11 with core 12, e.g., when solenoid 10 is energized. The path between these two end positions of valve needle 5 thus represents the lift. Spherical valve-closure member 7 cooperates with valve-seat surface 29, which tapers in the form of a truncated cone of valve-seat member 16.

Inserting atomizer disk 23 with a disk carrier 21 and clamping it as the means of attachment is just one possible variant of the mounting of atomizer disk 23. Such clamping as an indirect mounting of atomizer disk 23 on valve-seat member 16 has the advantage that it prevents temperature-induced deformation, which might occur in operations such as welding or soldering in the case of direct mounting of atomizer disk 23. Disk carrier 21, however, is by no means an exclusive condition for fastening atomizer disk 23.

FIG. 2 shows a top view of an atomizer disk known from Unexamined German Patent 196 39 506 for illustrating and explaining a possible design of atomizer disk 23 according to the present invention. Perforated disk 23 is designed as a flat circular component having multiple, e.g., three, axially successive function levels. In particular, FIG. 3, which is a sectional diagram along a line III-III in FIG. 2, illustrates the design of perforated disk 23 with its three function levels.

Top function level 37 has, for example, an inlet opening 40 having the largest possible extent and a contour like a stylized bat (or a double H). Inlet opening 40 has a cross section which could be described as a partially rounded rectangle having two opposing rectangular constrictions 45 and three inlet areas 46 projecting over constrictions 45. Four rectangular outlet openings 42, each being an equal distance from the central axis of atomizer disk 23 and arranged symmetrically around it, are provided in bottom function level 35.

Outlet openings 42 are situated in one plane (FIG. 2) largely in constrictions 45 in top function level 37 in a projection of all function levels 35, 36, 37 into one plane (FIG. 2). Outlet openings 42 are offset from inlet opening 40, i.e., inlet opening 40 does not cover outlet openings 42 at any point in this projection. To ensure fluid flow from inlet opening 40 to outlet openings 42, a channel 41 (cavity) is designed in middle function level 36. Channel 41 having the contour of a rounded rectangle is of a size such that it completely covers inlet opening 40 in the projection. Since channel 41 also covers four outlet openings 42, they may receive flow from all sides.

Function levels 37, 36 and 35 are shown again individually in FIGS. 2a, 2b and 2c to show precisely the opening contour of each individual function level 37, 36 and 35. Each individual figure is ultimately a simplified sectional diagram horizontally along each function level 37, 36 and 35.

Because of the offset of outlet openings 42 with respect to the at least one inlet opening 40 as mentioned above, the result is an S-shaped flow path of the medium, e.g., fuel. A radial velocity component is imparted to the medium through radial channel 41. A strong turbulence which promotes atomization is created due to the so-called S strike within atomizer disk 23, where flow is deflected sharply several times. The velocity gradient across the direction of flow is thus especially highly pronounced. The increased shear stresses in the fluid resulting from the differences in velocity promote disintegration of the fluid into fine droplets in the vicinity of outlet openings 42.

In the wake of introduction of onboard diagnostics (OBD) for internal combustion engines, electronic monitoring of functional reliability of components of a vehicle which are relevant for the exhaust gases is to be implemented in the future. One such variable to be monitored for fuel injectors is the quantity of fuel in a spray discharge per opening lift of valve needle 5. Therefore, according to the present invention, a microstructured atomizer disk 23 is proposed, having flow rate sensors with which active regulation of the quantity of fuel in a spray discharge over the duration of the injector triggering pulse is possible.

FIG. 4 shows an exemplary embodiment of an atomizer disk 23 according to the present invention having an integrated flow rate sensor but otherwise having the design described above as an example.

Atomizer disk 23 is made of a ceramic material, for example. In microstructuring of atomizer disk 23, electrically conducting regions 50, 51 are created in a controlled manner through a conductivity introduced locally into the material. In the exemplary embodiment illustrated in FIG. 4, electrically conducting regions 50, 51 are arranged in lower function level 35, i.e., in the bottom ceramic layer. Conductive regions 50, 51 end in contacting faces 50′, 51′ on the outer edge of atomizer disk 23. Atomizer disk 23 is secured-on the fuel injector so that these contacting surfaces 50′, 51′ come in contact with corresponding terminal contacts (not shown) of the injector. The measurement and control signals, which are sent to the flow rate sensor and picked up from it, may be processed in a control device external to the injector, for example.

Two electrically conducting strips 150, 151 run around the circumference of each individual outlet opening 42. These strips 150, 151 as part of electrically conducting regions 50, 51 are spaced a small relative distance apart. As already described above, outlet openings 42 are arranged so that they may receive the oncoming flow from channel 41 on all sides. The flow thus intersects strips 150, 151 approximately at a right angle before entering outlet openings 42. Strip 150, which is contacted via contacting surfaces 50′, is heated with a defined electric power. The heated fuel flow downstream from this strip 150 subsequently comes in contact with conducting strip 151, which is connected to contacting surfaces 51′. The heated fuel flow affects the temperature of strip 151, thus altering its electric resistance. Strip 151 is heated to different extents, depending on the flow rate, i.e., the velocity of flow. The instantaneous flow rate is determined on the basis of the electric resistance of strip 151 by an analyzer circuit. During operation of a motor vehicle and its fuel injectors, the flow rate through the injectors may thus be determined continuously. The flow may be monitored in this way and regulated actively at any time.

The flow rate measuring principle on an atomizer disk is not limited to atomizer disk 23, which is described in greater detail here, having an offset of inlet opening 40 and outlet openings 42, but instead completely different types of atomizer disks may also be used such as swirl disks. However, it is important for the flow rate sensor to always be located upstream from the metering cross section and in its immediate proximity.

Composite ceramics produced by pyrolysis of filled organosilicon polymers, such as those already known from European Patent 412 428 B1 or German Patent Application 195 38 695 A1, are preferably used as the material for conducting regions 50, 51 and nonconducting regions. The electric resistance of the composite ceramic may be adjusted through the type and quantity of filling. Microstructured atomizer disks 23 may be produced by hot stamping and joining of incompletely cured moldings or by joining them in the pyrolyzed state or by injection molding or transfer molding with broken-mold casting. Electrically conducting regions 50, 51 including strips 150, 151 are applied to bottom function level 35, a ceramic base plate 32, 55 of atomizer disk 23 either by doctor application or by screen printing, or they may be introduced by micro injection molding or transfer molding, or two-layer composites are produced from a nonconducting substrate and a thin conducting layer by cold pressing and subsequent laser structuring.

In the case of micro injection molding or transfer molding using an insert part, first the substrate, i.e., ceramic base plate 32, 55 is injection molded and then cured. Next, electric regions 50, 51 are produced in a second injection molding operation. In a following step, broken-mold casting is used to mold top function levels 36, 37 of atomizer disk 23 onto ceramic base plate 55, which has been provided with electric regions 50, 51.

In laser structuring, two variants of the process are conceivable. First, by laser abrasion (vaporization of the material at locations where no conducting regions 50, 51 are to be formed) may be used for structuring subsequent strips 150, 151. In addition, strips 150, 151 may be structured by partial pyrolysis at the locations of subsequent strips 150, 151, with subsequent removal of the remaining conductive composite compounds by etching. Parts produced in this way are pyrolyzed as described in European Patent 412 428 B1. It is important to recall here that the nonconductive composite ceramic (base plate 32, 55) and the conductive composite ceramic (strips 150, 151, contacting surfaces 50′, 51′) must be coordinated with regard to shrinkage due to pyrolysis and thermal expansion coefficients in order to prevent cracking during the pyrolysis operation.

What is claimed is:

1. An atomizer disk (23) having at least one inlet (40) and at least one outlet (42) and having a complete passage for a fluid between the inlet (40) and the outlet (42),
wherein a flow rate sensor (50, 51, 50′, 51′, 150, 151) is integrated into the atomizer disk (23) upstream from a metering cross section of the fluid passage.

2. The atomizer disk as recited in claim 1,
wherein the atomizer disk (23) is made of a ceramic material and has local, electrically conducting regions (50, 51).

3. The atomizer disk as recited in claim 1 or 2,
wherein electrically conducting regions (50, 51) are arranged directly upstream from the at least one outlet opening (42).

4. The atomizer disk as recited in claim 3,
wherein two electrically conducting strips (150, 151) run on the circumference of each outlet opening (42).

5. The atomizer disk as recited in claim 4,
wherein the strips (150, 151) are spaced a small distance apart.

6. The atomizer disk as recited in one of claims 3 through 5,
wherein a first electrically conducting region (50, 150) is heatable using electric power.

7. The atomizer disk as recited in claim 6,
wherein the temperature of a second electrically conducting region (51, 151) is influenceable by the fluid flow and thus its electric resistance is variable.

8. The atomizer disk as recited in claim 7,
wherein the flow rate upstream from a metering cross section of the fluid passage in the atomizer disk (23) may be determined using the electric resistance of the second electric region (51, 151).

9. The atomizer disk as recited in one of claims 2 through 8,
wherein the electrically conducting regions (50, 51, 150, 151) on the outer edge of the atomizer disk (23) end in contacting surfaces (50′, 51′) which are connectable to terminal contacts leading to an analyzer circuit.

10. The atomizer disk as recited in claim 2,
wherein composite ceramics produced by pyrolysis of filled organosilicon polymers are used as the material for the atomizer disk (23).

11. A fuel injector for fuel injection systems of internal combustion engines having an actuator (10, 11, 12), having a movable valve part (5) which cooperates with a fixed valve seat (29) for opening and closing the valve, and having an atomizer disk (23), situated downstream from the valve seat (29), designed to have at least one inlet (40) and at least one outlet (42) and a complete passage for fuel between the inlet (40) and the outlet (42), wherein a flow rate sensor (50, 51, 50′, 51′, 150, 151) is integrated into the atomizer disk (23) upstream from a metering cross section of the fuel passage.

12. The fuel injector as recited in claim 11,
wherein the atomizer disk (23) is made of a ceramic material and has local, electrically conducting regions (50, 51).

13. The fuel injector as recited in claim 11 or 12,
wherein electrically conducting regions (50, 51) are arranged directly upstream from the at least one outlet opening (42).

14. The fuel injector as recited in claim 13,
wherein a first electrically conducting region (50, 150) is heatable using electric power, and the temperature of a second electrically conducting region (51, 151) is influenceable by the fuel flow and thus its electric resistance is variable, whereby the flow rate upstream from a metering cross section of the fuel passage in the atomizer disk (23) is determinable.

15. The fuel injector as recited in one of claims 12 through 14, wherein at the outer edge of the atomizer disk (23), the electrically conducting regions (50, 51, 150, 151) end in contacting surfaces (50′, 51′) which are connectable to terminal contacts leading to an analyzer circuit.

16. The fuel injector as recited in claim 15,
wherein the atomizer disk (23) is electrically connectable to a control device using the contracting surfaces (50′, 51′).
